(19) United States
(12) Patent Application Publication
(10) Pub. No.: US 2006/0274689 A1
(43) Pub. Date: Dec. 7, 2006

(54) Method for using dedicated rate control in a common rate control wireless communications system

(76) Inventors: Shupeng Li, Edison, NJ (US); Sudhir Ramakrishna, New York, NY (US); Ashok N. Rudrapatna, Basking Ridge, NJ (US)

Correspondence Address: WILLIAMS, MORGAN & AMERSON, 10333 RICHMOND, SUITE 1100, HOUSTON, TX, 77042, US

(21) Appl. No.: 11/143,090

(22) Filed: Jun. 2, 2005

(51) Int. Cl. H04Q 7/00; H04L 12/66

(52) U.S. Cl. 370/329; 370/352

(57) ABSTRACT

A method is provided for controlling communications between a base station and a mobile device. The method comprises transmitting dedicated rate control information to the mobile device within a common rate control communications system. For example, dedicated rate control information may be embedded in a data packet and delivered to the mobile device over a data channel. The mobile device may be configured to extract the embedded dedicated rate control information from the data packet and use the information to control aspects of its transmission, such as time slot and rate.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of base stations distributed within an area to be serviced by the system. Various mobile devices within the area may then access the system and, thus, other interconnected telecommunications systems, via one or more of the base stations. Typically, a mobile device maintains communications with the system as it passes through an area by communicating with one and then another base station, as the mobile device moves. The mobile device may communicate with the closest base station, the base station with the strongest signal, the base station with a capacity sufficient to accept communications, etc.

In wireless communications systems, the base station typically schedules the time periods in which the mobile device is permitted to transmit information to the base station and the rate at which the mobile device transmits. Generally, there are two types of systems, Common Rate Control (CRC) and Dedicated Rate Control (DRC). In systems that employ CRC, a common signal is transmitted to all of the mobile devices, controlling them in mass. CRC has the advantage of low overhead with respect to the signaling required, but has the disadvantage of being unable to achieve a “custom” control tailored to individual mobile devices. DRC, on the other hand, allows for a more direct control of individual mobile devices, but at the expense of greater overhead in the amount of signaling that needs to be provided.

The present invention is directed to overcoming, or at least reducing, the effects of one or more of the problems set forth above.

### SUMMARY OF THE INVENTION

In one aspect of the instant invention, a method is provided for controlling communications between a base station and a mobile device. The method comprises transmitting dedicated rate control information to the mobile device within a common rate control communications system.

In another aspect of the instant invention, a method is provided for controlling communications between a base station and a mobile device. The method comprises receiving dedicated rate control information at the mobile device within a common rate control communications system. The mobile device controls its transmissions to the base station based on the dedicated rate control information.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system, in accordance with one embodiment of the present invention; and

FIG. 2 depicts a block diagram of one embodiment of a base station and a mobile device in the communications system of FIG. 1; and

FIGS. 3A and 3B depict flow charts of one embodiment of a method that may be used to schedule transmissions by the mobile devices of FIGS. 1 and 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

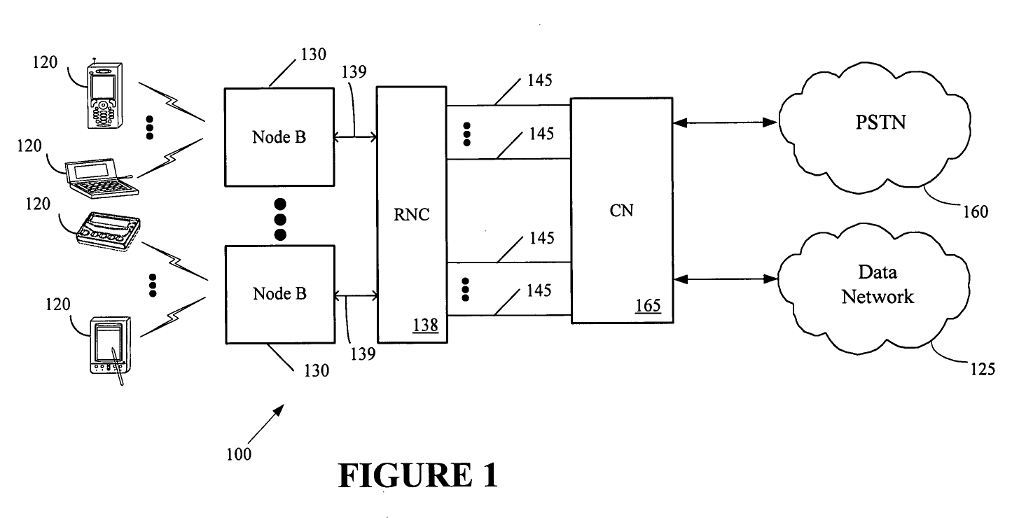

Turning now to the drawings, and specifically referring to FIG. 1, a communications system 100 is illustrated, in accordance with one embodiment of the present invention. For illustrative purposes, the communications system 100 of FIG. 1 is a Code Division Multiple Access (CDMA), although it should be understood that the present invention may be applicable to other systems that support data and/or voice communications, such as a Universal Mobile Telephone System (UMTS). The communications system 100 allows one or more mobile devices 120 to communicate with a data network 125, such as the Internet, and/or a Publicly Switched Telephone Network (PSTN) 160 through one or more base stations 130. The mobile device 120 may take the form of any of a variety of devices, including cellular phones, personal digital assistants (PDAs), laptop computers, digital pagers, wireless cards, and any other device capable of accessing the data network 125 and/or the PSTN 160 through the base station 130.

In one embodiment, a plurality of the base stations 130 may be coupled to a Radio Network Controller (RNC) 138 by one or more connections 139, such as T1/EI lines or circuits, ATM circuits, cables, optical digital subscriber lines (DSLs), and the like. Although one RNC 138 is illustrated, those skilled in the art will appreciate that a plurality of RNCs 138 may be utilized to interface with a large number of base stations 130. Generally, the RNC 138 operates to control and coordinate the base stations 130 to which it is connected. The RNC 138 of FIG. 1 generally provides replication, communications, runtime, and system management services. The RNC 138, in the illustrated embodiment handles calling processing functions, such as setting and terminating a call path and is capable of determining a data transmission rate on the forward and/or reverse link for each user 120 and for each sector supported by each of the base stations 130.

The RNC 138 is also coupled to a Core Network (CN) 165 via a connection 145, which may take on any of a variety of forms, such as T1/EI lines or circuits, ATM circuits, cables, optical digital subscriber lines (DSLs), and the like. Generally the CN 165 operates as an interface to a data network 125 and/or to the PSTN 160. The CN 165 performs a variety of functions and operations, such as user authentication, however, a detailed description of the structure and operation of the CN 165 is not necessary to an understanding and appreciation of the instant invention. Accordingly, to avoid unnecessarily obfuscating the instant invention, further details of the CN 165 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

Thus, those skilled in the art will appreciate that the communications system 100 facilitates communications between the Users 120 and the data network 125 and/or the PSTN 160. It should be understood, however, that the configuration of the communications system 100 of FIG. 1 is exemplary in nature, and that fewer or additional components may be employed in other embodiments of the communications system 100 without departing from the spirit and scope of the instant invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

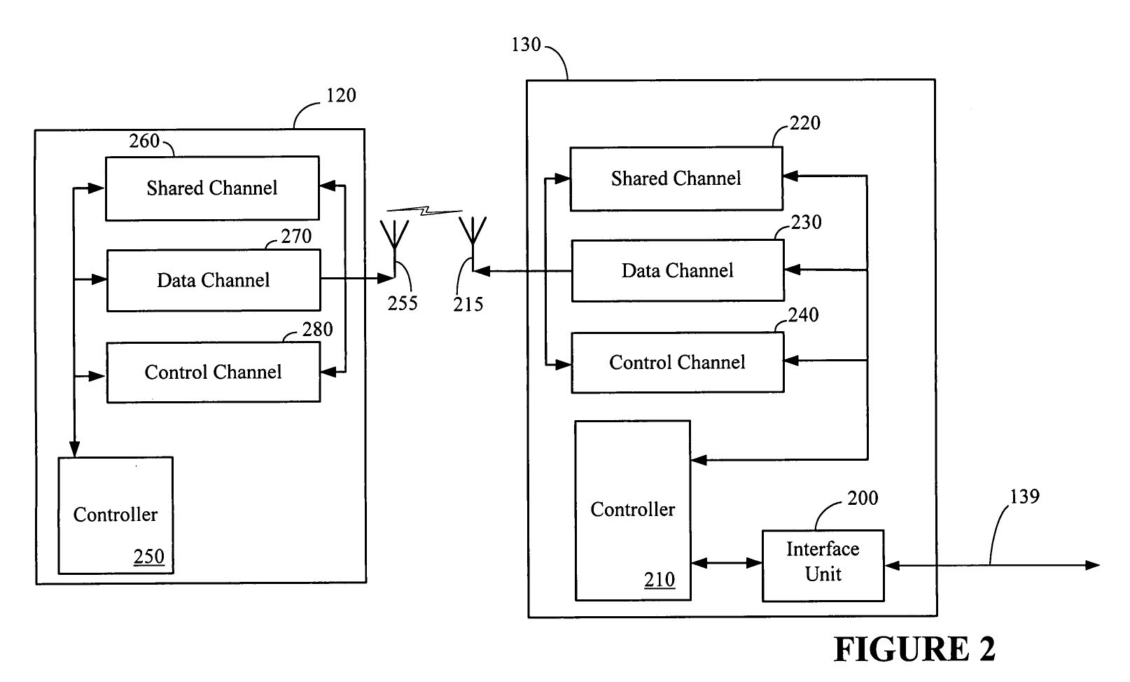

Referring now to FIG. 2, a block diagram of one embodiment of a functional structure associated with an exemplary base station 130 and mobile device 120 is shown. The base station 130 includes an interface unit 200, a controller 210, an antenna 215 and a plurality of channels, such as a shared channel 220, a data channel 230, a control channel 240, and the like. The interface unit 200, in the illustrated embodiment, controls the flow of information between the base station 130 and the RNC 138 (see FIG. 1). The controller 210 generally operates to control both the transmission and reception of data and control signals over the antenna 215 and the plurality of channels 220, 230, 240 and to communicate at least portions of the received information to the RNC 138 via the interface unit 200.

The mobile device 120 shares certain functional attributes with the base station 130. For example, the mobile device 120 includes a controller 250, an antenna 255 and a plurality of channels, such as a shared channel 260, a data channel 270, a control channel 280, and the like. The controller 250 generally operates to control both the transmission and reception of data and control signals over the antenna 255 and the plurality of channels 260, 270, 280.

Normally, the channels 260, 270, 280 in the mobile device 120 communicate with the corresponding channels 220, 230, 240 in the base station 130. Under the operation of the controllers 210, 250, the channels 220, 260; 230, 270; 240, 280 are used to effect a controlled scheduling for communications from the mobile device 120 to the base station 130.

Typically, operation of the channels 260, 270, 280 in the mobile device 120 and the corresponding channels 220, 230, 240 in the base station 130 have been time slot operated. For example, in each forward link (FL) time slot, control information meant for all of the mobile devices 120 connected to the base station 130 is transmitted, in addition to user data for at least a portion of those mobile devices 120, all from a single base station antenna. Typically, the control information may include information regarding the timing and rate at which the mobile devices 120 are permitted to transmit. As discussed above, this is generally known as Common Rate Control (CRC).

In one embodiment of the instant invention, one or more of the channels 260, 270, 280 in the mobile device 120 and the corresponding channels 220, 230, 240 in the base station 130, which would ordinarily be used to effect a CRC, may be utilized to effect a Dedicated Rate Control (DRC) in one or more of the mobile devices 120. In some embodiments of the instant invention, it may be useful to design the system to operate with legacy mobile devices 120 that are not configured to operate in a DRC mode.

In one embodiment of the instant invention, DRC-related signaling information may be conveyed to a particular mobile device 120 by embedding the signaling information into the data packet transmitted on the data channel 230. Both the base station 130 and the mobile device 120 are configured to “understand” the protocol used to embed the DRC signaling, allowing the mobile device 120 to interpret a DRC-signal-carrying data packet correctly. The base station 130 may utilize a combination of DRC and CRC to control the RL transmissions of the various mobile devices 120.

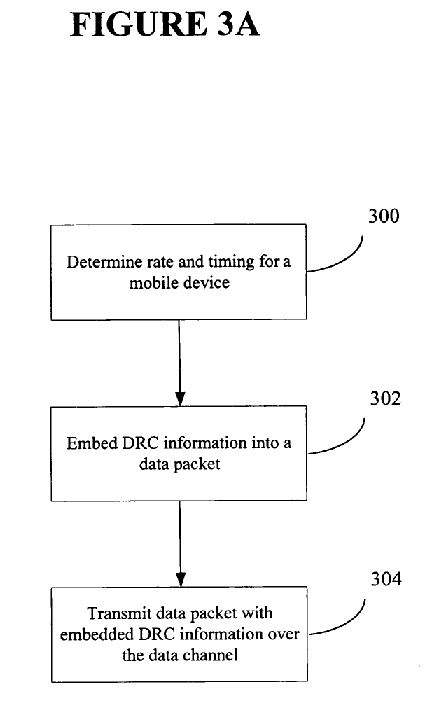

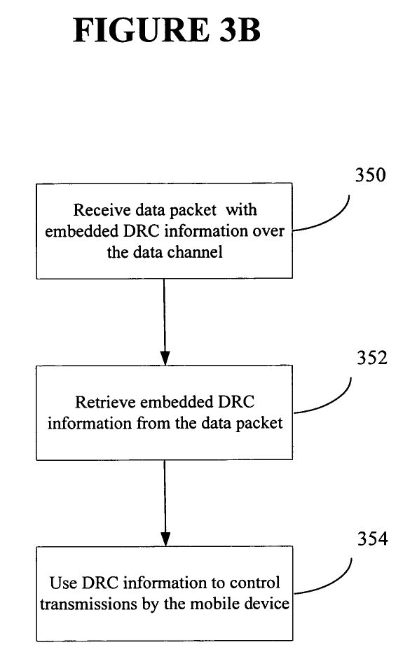

Turning now to FIG. 3A, a flow chart of a method that may be employed by the base station 130 to deliver the DRC information to a particular one of the mobile devices 120 is shown. The process begins at block 300 with the base station 130 determining DRC information, such as the rate and timing of a reverse link transmission of a particular one of the mobile devices 120. Any one of a variety of well known methodologies may be employed to determine a desired rate and timing for transmissions by a particular one of the mobile devices 120, and thus, to avoid unnecessarily obfuscating the instant invention, the details of such a process are not described herein.

At block 302, the DRC information is embedded into a data packet. Those skilled in the art will appreciate that the DRC information embedded into the data packet may include a unique identifier associated with one, or at least a subset of, the mobile devices 120. As discussed in greater below in conjunction with FIG. 3B, the unique identifier allows the mobile device 120 to discern when it is the target of the DRC information.

At block 304, the base station 130 transmits the data packet with the embedded DRC information over the data channel 230. Turning now to FIG. 3B, the operation of a representative one of the mobile devices 120 is described in an exemplary flow chart. At block 350, the mobile device 120 receives the data packet with the embedded DRC information. At block 352, the mobile device 120 retrieves the DRC information from the packet and examines the DRC information to determine if it is directed to this particular mobile device 120. For example, in one embodiment of the instant invention, the mobile device may examine the unique identifier, and if it matches a unique identifier associated with the mobile device 120, then the DRC information may be used to control transmissions from the mobile device 120 at block 354.

On the other hand, if the unique identifier embedded in the data packet does not match the unique identifier associated with the mobile device 120, then the mobile device 120 will ignore the DRC information contained in the data packet. If no DRC information is received, then the mobile device 120 may rely upon CRC information to control transmissions to the base station 130.

Those skilled in the art will appreciate that the mobile devices 120 may be controlled by a combination of CRC and DRC information. That is, certain aspects of the transmissions from a particular one of the mobile devices 120 may be partially controlled by CRC information while other aspects of the transmissions may be controlled by DRC information.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

1. A method for communicating between at least one base station and at least one mobile device, comprising:
transmitting dedicated rate control information to the least one mobile device within a common rate control communications system.

2. A method, as set forth in claim 1, wherein transmitting dedicated rate control information to the mobile device within the common rate control communications system further comprises transmitting dedicated rate control information in a data packet.

3. A method, as set forth in claim 1, wherein transmitting dedicated rate control information to the mobile device within the common rate control communications system further comprises transmitting dedicated rate control information in a data packet over a data channel.

4. A method, as set forth in claim 1, further comprising transmitting common rate control information to the mobile device.

5. A method for communicating between at least one base station and at least one mobile device, comprising:
receiving dedicated rate control information at the least one mobile device within a common rate control communications system; and
controlling transmissions from the at least one mobile device to the at least one base station based on the dedicated rate control information.

6. A method, as set forth in claim 5, wherein receiving dedicated rate control information at the mobile device within the common rate control communications system further comprises receiving dedicated rate control information in a data packet.

7. A method, as set forth in claim 5, wherein receiving dedicated rate control information at the mobile device within the common rate control communications system further comprises receiving dedicated rate control information in a data packet over a data channel.

8. A method, as set forth in claim 1, further comprising receiving common rate control information at the mobile device, and wherein controlling transmissions from the mobile device to the base station based on the dedicated rate control information further comprises controlling transmissions from the mobile device to the base station based on the dedicated rate control information and the common rate control information
